(19) United States
(12) Patent Application Publication
(10) Pub. No.: US 2025/0341697 A1
(43) Pub. Date: Nov. 6, 2025

(54) ADAPTER MODULE CONFIGURED TO PROVIDE ENHANCED CABLE MANAGEMENT, SUPPORT DIFFERENT BULKHEAD SHAPES, AND/OR SELECTIVE PANEL ENGAGEMENT WITHOUT REQUIRING A TOOL

(71) Applicant: PPC BROADBAND, INC., East Syracuse, NY (US)

(72) Inventors: Sandeep PULIYANKULANGARA, Edathala (KL) (IN); Derek FURTADO, Salcette (IN)

(73) Assignee: PPC BROADBAND, INC., East Syracuse, NY (US)

(21) Appl. No.: 19/200,385

(22) Filed: May 6, 2025

(30) Foreign Application Priority Data
May 6, 2024 (IN) 202411035768

(51) Int. Cl. G02B 6/44; G02B 6/38

(52) U.S. Cl. CPC G02B 6/4446; G02B 6/3825; G02B 6/3897; G02B 6/44528

(57) ABSTRACT

A fiber optic adapter module may have a body portion, a tray portion that may be configured to be movingly coupled with the body portion, a cable access portion that may be configured to permit a fiber optic cable to enter an interior of the body portion, and a knockout portion. The tray portion may be configured to be pivotally coupled with the body portion such that the tray portion may be configure to selectively move relative to the body portion between a stowed position and a raised position. The knockout portion may have multiple knockout portions that may be configured to be separately removed from the body portion so as to be selective change an opening shape of the body portion, such as by providing a first opening shape arranged to selectively engage a first bulkhead adapter shape and/or selectively engage a first fiber connector or a second opening shape arranged to selectively engage a second bulkhead adapter shape and/or selectively engage a second fiber connector different from the first fiber connector.

### CROSS-REFERENCE TO RELATED APPLICATION

This application claims the benefit of Indian Provisional Application No. 20/241,1035768, filed in India on May 6, 2024, which is currently pending, the disclosure of which is hereby incorporated by reference herein in its entirety.

### TECHNICAL FIELD

The present disclosure is directed to an adapter module and, more particularly, may be directed to a compact adapter module that is configured to provide enhanced cable management, such as by being configured to support different adapter bulkheads shapes and/or enable engagement with a panel portion without necessarily requiring the use of a tool.

### BACKGROUND

Progression of the generation, transmission, and storage of data has prompted hardware advancements for distributed networks that service such data. Increased bandwidth and signal speed corresponding with distributed network hardware advancements may accommodate diverse demands of data users. However, such hardware advancements may introduce physical complexity that poses challenges for initial installation as well as rework operations.

For instance, greater numbers, and types, of cable connections may be needed to provide sufficient wired signal pathways to satisfy bandwidth and speed thresholds of a distributed network. Larger numbers of cables and/or cable connections may threaten physical constraints present in some residential, commercial, and industrial sites. For these reasons, it is a continued goal for signal carrying cables to be managed and organized with greater physical density and more efficient access during installation and subsequent operation.

It may be desirable to provide an adapter module that is structurally configured to permit use with different sized adapter bulkheads. In some aspects, it may be desirable to provide an adapter module that is configured to provide enhanced cable management and/or enhanced coupling with a patch panel, rack, or the like.

### SUMMARY

In accordance with various aspects of the disclosure, a fiber optic adapter module may be configured to permit use with different sized adapter bulkheads with a body portion and a tray portion configured to be movingly coupled with the body portion. The body portion may have a cable access portion that is configured to permit a fiber optic cable to enter an interior of the body portion. The tray portion may be configured to be pivotally coupled with the body portion so as to permit selective rotation of the tray portion relative to the body portion between a stowed position and a raised position. The body portion may have a knockout portion configured to be removed from a remainder of the body portion so as to provide an opening that is configured to receive a fiber optic adapter. The knockout portion may have multiple knockout portions that may be configured to be separately removed from the body portion such that the knockout portion permits selective sizing of the opening in the body portion so as to alternatively provide a first opening, which may be configured to receive a first bulkhead adapter that may have a first bulkhead adapter shape and that may be configured to receive a first fiber connector, and/or a second opening, which may be configured to receive a second bulkhead adapter that may have a second bulkhead adapter shape that is different from the first bulkhead adapter shape, and that may be configured to receive a second fiber connector different from the first fiber connector.

A fiber optic adapter module, in accordance with some embodiments, may permit use with different sized adapter bulkheads with a body portion, a lid portion, and a tray portion. The lid portion may be coupled with the body portion. The tray portion may be movingly coupled with the body portion. The body portion may have a cable access portion that may permit a fiber optic cable to enter an interior of the body portion. The tray portion may be configured to be pivotally coupled with the body portion so as to permit selective rotation of the tray portion relative to the body portion between a stowed position and a raised position. The body portion may have a knockout portion that may be configured to be removed from a remainder of the body portion so as to provide an opening that is configured to receive a fiber optic adapter. The knockout portion may have multiple knockout portions that may be configured to be separately removed from the body portion such that the knockout portion permits selective sizing of the opening in the body portion so as to alternatively provide a first opening sized to receive a first bulkhead adapter having a first size and may receive a first fiber connector or a second opening sized to receive a second bulkhead adapter having a second size, different from the first size, and may receive a second fiber connector different from the first fiber connector.

Embodiments of a fiber optic adapter module may permit use with different sized adapter bulkheads with a body portion, a lid portion, and a tray portion. The lid portion may be coupled with the body portion. The tray portion may be movingly coupled with the body portion. The body portion may have a cable access portion that may permit a fiber optic cable to enter an interior of the body portion. The tray portion may be pivotally coupled with the body portion so as to permit selective rotation of the tray portion relative to the body portion between a stowed position and a raised position. The body portion may have a base portion having a support portion extending from the base portion and may support the tray portion in the stowed position. The support portion may space the tray portion from the base portions so as to permit fiber optic components and/or slack cable to be stored between the based portion and the tray portion. The body portion may have an engagement portion that may couple the body portion with a retention portion. The engagement portion may flex such that the engagement portion can be coupled with and decoupled from the retention portion so as to provide toolless coupling and decoupling of the body portion relative to the retention portion. The body portion may have a knockout portion that may be removed from a remainder of the body portion so as to provide an opening that is configured to receive a fiber optic adapter. The knockout portion may have multiple knockout portions that may be configured to be separately removed from the body portion such that the knockout portion permits selective sizing of the opening in the body portion so as to alternatively provide a first opening sized to receive a first bulkhead adapter having a first size and may receive a first fiber connector or a second opening sized to receive a second bulkhead adapter having a second size, different from the first size, and may receive a second fiber connector different from the first fiber connector.

### BRIEF DESCRIPTION OF THE DRAWINGS

Further advantages and features of the present disclosure will become apparent from the following description and the accompanying drawings, to which reference is made.

FIG. 1 is a line representation of portions of a distributed network in which assorted embodiments can be practiced.

FIG. 2 is a line representation of portions of an interconnect portion that may be employed in the distributed network of FIG. 1 in various embodiments.

FIG. 3 is a line representation of aspects of cable management system structurally configured in accordance with some embodiments of this disclosure.

FIG. 4 is a perspective view of portions of a compact adapter module that may be employed in the cable management system of FIG. 3 in accordance with assorted embodiments of this disclosure.

FIG. 5 is a partially exploded perspective view of aspects of a compact adapter module that may be utilized in the cable management system of FIG. 3 in accordance with various embodiments of this disclosure.

FIG. 6 is a partially exploded perspective view of portions of a compact adapter module that may be employed in the cable management system of FIG. 3 in accordance with some embodiments of this disclosure.

FIG. 7 is a perspective view of aspects of a compact adapter module that may be utilized in the cable management system of FIG. 3 in accordance with assorted embodiments of this disclosure.

FIG. 8 is a top view of aspects of a compact adapter module structurally arranged in accordance with some embodiments of this disclosure.

FIG. 9 is a perspective view of portions of a cable management system configured and operated in accordance with various embodiments of this disclosure.

### DETAILED DESCRIPTION

Embodiments of the disclosure arrange a cable management system with one or more compact adapter modules that each have manual tab portions to allow efficient access, installation, and alteration over time.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The connection of separate signal carrying cables may be facilitated in a variety of different manners. However, some conventional cable connections may be physically inefficient, cumbersome, and/or complex. Hence, assorted embodiments are generally directed to a physically efficient module that provides modular connectivity and access that promotes quick and accurate physical manipulation as well as options for different signal pathway connections.

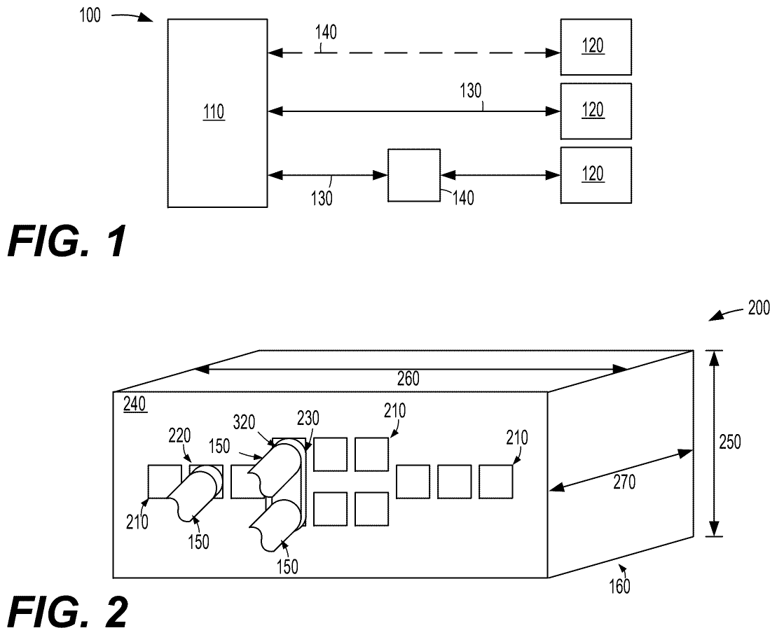

FIG. 1 illustrates a line representation of a distributed network 100 in which various embodiments cable management system may be practiced. The distributed network 100 may enable one-way, or two-way, communications between any number of sources 110 and destinations 120. Such communications may utilize one or more signal pathways provided by wireless 130 and/or wired 140 means.

The distributed network 100 may connect sources 110 to one or more destinations with individual signal pathways, as shown by the segmented wireless pathway 130 and solid wired pathway 140. Embodiments of the distributed network 100 may employ multiple separate signal carrying cables 150, connected by one or more interconnects 160, to allow communications between sources 110 and destinations 120. An interconnect 160 may be any active or passive component, such as a switch, cassette, splitter, or adapter, that physically engages separate cables 150 to provide at least one stable signal pathway.

FIG. 2 illustrates portions of a distributed network 200 that employs an interconnect 160 in accordance with various embodiments to connect sources 110 to destinations 120. The interconnect 160 may facilitate physical and digital engagement of any number, and type, of cables 150 with assorted ports 210. For instance, cables 150 with differing diameters, signal carrying components, and/or connectors may engage separate ports 210 to provide a variety of connection configurations, such as splitting, reducing, or switching between different signal pathways.

In the non-limiting embodiment shown in FIG. 2, the interconnect 160 concurrently provides different connection ports 210 that allow simplex 220 and duplex 230 cable engagement. Within the housing 240 of the interconnect 160, one or more connection components, such as adapters, splices, connectors, splitters, and cassettes, are selectively utilized to provide stable signal pathways. However, the physical size of the interconnect housing 240 may be inhibitive of where the interconnect 160 may be employed in a distributed network 200. That is, the housing 240 may have a height 250, width 260, and/or depth 270 that are too large to physically fit in some patch panels, dome closures, wall boxes, street cabinets, or other enclosure.

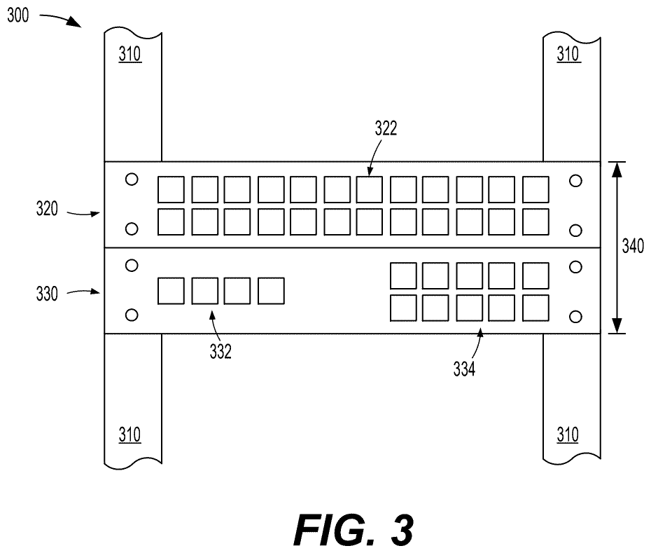

FIG. 3 illustrates a front view line representation of portions of a distributed network 300 that employ interconnects to provide selective utilization of separate signal carrying cables to establish and maintain stable signal pathways. While the interconnect 160 of FIG. 2 conveys how a housing 240 may provide ports 210 and be incorporated into a variety of different enclosures, various embodiments mount network interconnects in a rack 310 to allow for stable physical isolation and consistent access.

As shown, multiple separate interconnects may be concurrently mounted within a common rack 310. Although rack-mounted interconnects may have matching capabilities and/or configurations, assorted interconnects may be added, removed, or moved within the rack 310 at any time, which allows for diverse physical arrangements, access, and cable densities. As such, the rack 310 may physically support a first interconnect 320 that provides different capabilities and/or performance than a second interconnect 330. It is noted that the respective interconnects 320/330 may be physically positioned anywhere within the rack 310, which allows for a variety of cable organizing configurations.

In a non-limiting embodiment, the first interconnect 320 has a plurality of ports 322 that allow for selective switching between different cables connected to the respective ports 322 via individual, or collective, connectors, as illustrated in FIG. 2. The signal pathway formation by combining and/or selecting from different cables replaces needing large numbers of different interconnects to provide the same capabilities. While the first interconnect 320 may provide a variety of different cable combinations to form stable signal pathways, some embodiments utilize a separate, second interconnect 330 to provide a single cable combination purpose. For instance, the second interconnect 330 may provide input ports 332 and output ports 334 that provide splitting, or expander, capabilities for the distributed network 300.

Through the use of one or more rack-mounted interconnects 320/330, the distributed network 300 may provide robust communications and signal reliability. However, cable organization and port access may be inefficient in some rack 310 configurations, particularly as more of the available ports 322/332/334 are occupied. Such inefficiency may be compounded by increased volumes of cable maintenance and/or reworking operations. For instance, upgrading cables, adding output destinations, and changing types of cable connections may be inefficient with some rack 310 arrangements as the interconnects 320/330 have static positions in the rack 310 and a relatively limited available cable combination capabilities.

Accordingly, various embodiments are directed to a cable management system that utilizes interconnect modules to provide efficient port access and cable organization over time. The assorted embodiments of a cable management system structurally configure interconnects with a relatively compact physical size, which allows for greater practical uses and access over time.

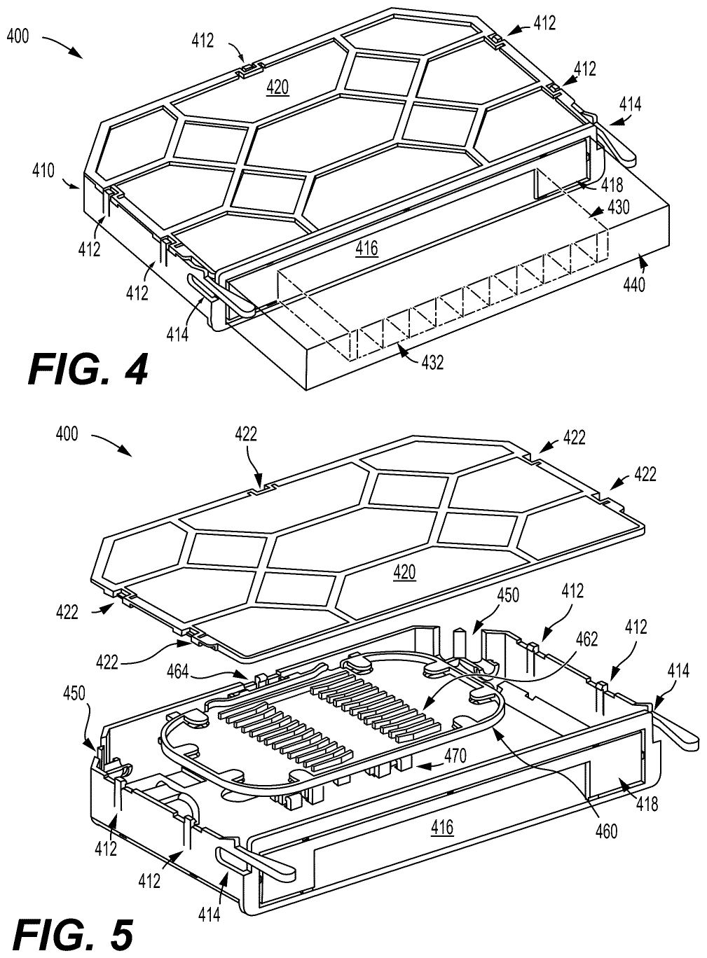

FIGS. 4-7 respectively illustrate assorted aspects of a compact adapter module 400 that may be employed in a cable management system in accordance with some embodiments. The compact adapter module 400 shown in FIG. 4 has a body portion 410 that is closed by a lid portion 420. The body portion 410 may be a unitary body portion and may be any size, shape, and material. In some embodiments, the body portion may be structurally configured with a lightweight material, such as a polymer or carbon fiber, that engages the lid portion 420 to define and protect an internal cavity where one or more cable connections are facilitated.

While not required, the lid portion 420 may be secured to the body portion 410 via an attachment portion 412, which may include, for example, several attachment portions spread along the periphery of the body portion 410. The compact adapter module 400 may employ any number, type, and position of attachment portions 412 to provide physical, magnetic, electrical, and/or environmental protection. For instance, the body portion 410 may physically connect to the lid portion 420 with a variety of differently configured, or matching, attachment features, such as tabs, keys, snaps, hooks, or levers. The respective attachment portions 412 may provide permanent, or selectable, physical connection of the lid and body portions to form a rigid structure that protects the cable connections housed inside.

The body portion 410, as shown in the exemplary embodiment, may have a manual tab engagement portion 414. The manual tag engagement portion 414 may comprise an engagement portion 414 on opposite sides of a bulkhead portion 416. Physical manipulation of the engagement portion 414, for example, of one or both engagement portions 414, may allow the body portion 410 and attached lid portion 420 to selectively be secured to a retention plate as part of a cable management system, as shown in FIG. 9.

The size, mechanism, and position of the tab engagement portions 414 are not limited to a particular arrangement, but some embodiments employ cantilevered tabs with shapes and sizes that physically retain the body portion 410 in a retention plate until each engagement portion 414 is manually depressed to free the body portion 410. The movement and retention of the engagement portions 414 may be provided with any number of mechanical, pneumatic, magnetic, or hydraulic means that assist in providing selectable retention, and release, from a retention plate aspect of a cable management system.

In the non-limiting embodiment of the compact adapter module 400 shown in FIGS. 4-8, the body portion 410 and lid portion 420 respectively have a perimeter shape and size that is relatively small compared to the rack mounted interconnects 320/330 shown in FIG. 3. That is, the exterior of the compact adapter module 400 may have a size and shape that fits in a single hand of a user while providing keyed aspects to aid in the alignment of the body portion 410 in a retention plate. In other words, the compact adapter module 400 may be physically constructed to be small and present slopes, surfaces, and features that only allow the body portion 410 to be inserted, and removed, from a retention plate in a single orientation, such as with the lid portion 420 facing upward relative to the body portion 410.

The compact adapter module 400 may provide a variety of different connection capabilities. As illustrated, an exterior of the body portion 410 is arranged to provide an opening 416 through which a bulkhead portion may be physically positioned. To accommodate a variety of different types and sizes of bulkhead portions, the body portion 410 may have one or more knockout portions 418 that may be removed at will. Some embodiments of the knockout portions 418 attach one or more separate pieces, which may be rigid, semi-rigid, or flexible, to the body portion 410 with one or more fastening aspects, such as frangible connection portion, adhesive, or fasteners.

Other embodiments structurally configure the knockout portion 418 as a region of the body portion 410 that is partially separated with one or more holes, apertures, slots, or cuts that allow for an efficient removal of knockout portions 418 to provide a sufficient continuous opening 416 so that a bulkhead adapter 430/440 may be securely attached to the body portion 410. Such structural arrangement may result from molding, casting, or material processing. With the arrangement of knockout portions 418, the opening 416 may efficiently be configured in the field by a technician to connect bulkhead adapters 430/440 with different sizes to the body portion 410, as generally illustrated by the solid and segmented aspects of FIG. 4.

As a result of the ability to accommodate differently sized bulkhead adapters 430/440, different connectivity and/or cable connection capabilities may be selectively provided, such as different numbers, or types, of cable ports 432. For example, the bulkhead adapter 430 may comprise a Lucent Connector (LC) adapter having connection ports configured to receive LC connectors, and the bulkhead adapter 440 may comprise a Subscriber Connector (SC) adapter having connection ports configured to receive SC connectors. Of course, various other bulkhead adapters having connection ports configured to receive various other fiber optic connector may be received in the opening 416 of the module 400.

An interior cavity portion defined by the body portion 410 may be accessed in a variety of different manners. For instance, a cable may enter, or exit, the body portion 410 via an adapter portion 430/440 or an access portion 450, for example, an aperture, that is sized to allow for efficient physical securement of a signal carrying cable relative to the body portion 410. As shown, the body portion 410 may present a number of differently arranged access portions 450, such as different diameters and/or orientations relative to the body portion 410, which increases the compatibility of the module 400 with assorted cables, such as, for example, 3 mm diameter fiber optic cables.

A tray portion 460, as shown in FIG. 5, may be incorporated into the body portion 410 to enable connection of one or more signal carrying fibers. The non-limiting embodiment illustrated in FIG. 5 conveys how the tray portion 460 may enable splice fiber cable connections via a splice connector that is physically supported by a splice portion 462. It is noted that the tray portion 460 has a plurality of splice portions 462, which may allow for a plurality of separate, and concurrent, splice connections.

The tray portion 460, in some embodiments, is not statically positioned within the body portion 410 and may be moved, tilted, turned, or removed at will via a movement portion 464. For instance, the movement portion 464 may allow for selective rotation or pivoting of some, or all, of the tray portion 460 relative to the body portion 410. Such rotation, or other tray portion movement or removal, may expose an underlying connection portion 470 that is otherwise covered by the tray portion 460. Hence, the position, and structural configuration of the tray portion 460 allows for secure positioning above the connection portions 470 to allow for concurrent connections via the splice portions 462 and one or more aspects of the connection portions 470.

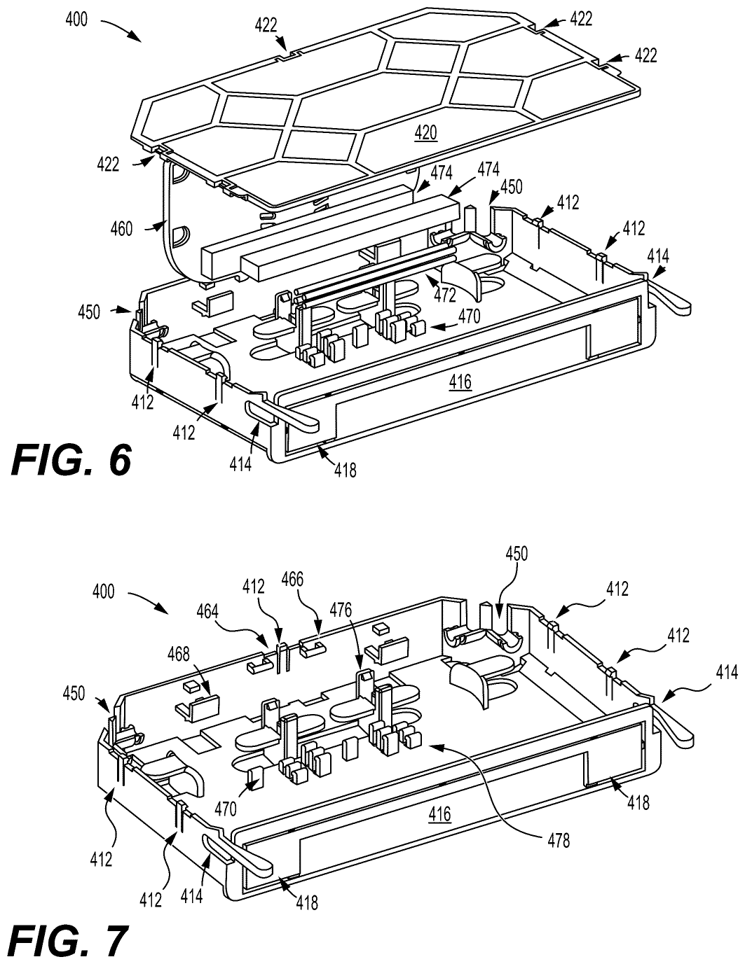

FIG. 6 illustrates a perspective view of the compact adapter module 400 with interior components exploded, for clarity. By removing the lid portion 420 and rotating, or pivoting, the tray portion 460, which is allowed by the physical configuration of the movement portion 464, the assorted connection features 270 are exposed. Although not required or limiting, the compact adapter module 400 is structurally configured with a variety of different physical supports for aspects that allow separate signal carrying fiber optic cores to be joined to form stable signal pathways through the module 400.

The connection portion 470 may support and contain one or more hollow sleeves 472 that may be employed to facilitate and/or protect a union, such as a fiber optic core splice. The hollow sleeves 472, in some embodiments, may be stored in the physical supports of the connection portion 470 until being utilized in the tray portion 460. The connection portion 470 may also provide physical support, and retention, of one or more components 474 that facilitate signal pathway connections, such as adapters, connectors, switches, and/or splitters. The ability to combine different types of signal carrying cables with various splicing and connection components 474 allows the module 400 to provide a robust range of connectivity in a physically small package.

With the vertical stacking of the tray portion 460 on top of the connection portion 470, the exterior dimensions of the body portion 410 may be reduced relative to other conventional interconnects, such as interconnects 320/330 of FIG. 3. As a result of the small physical size of the module 400, a technician may efficiently handle the module 400 during installation, removal, or reworking of cable connections. For instance, the module 400 may be securely handled in a single hand of a technician, which allows a free hand to efficiently manipulate the bulkhead adapters 430/440, splices, component 474 connections, and access portion 450 to provide new, or different, connection configurations. It is noted that the size of the module 400 can be particularly effective at increasing connection installation, or alteration, efficiency when one or more cables are physically attached to the module 400 via the access portion 450 and/or the bulkhead adapters 430/440.

The perspective view of the body portion 410 in FIG. 7 illustrates how the movement portion 464 may have retention portions 466, for example, stationary posts, that facilitate retention and rotation. It is contemplated that the post portions 466 are structurally configured to allow the tray portion 460 to be selectively removed and reinserted cyclically over time. The operation of the tray portion 460 may be further supported by aspects of the connection features 470, such as support portions 476, for example, stations, that restrict the rotational range of the tray portion 460 while preventing the tray portion 460 from contacting the components 474 and sleeves 472 supported by the connection portion 470.

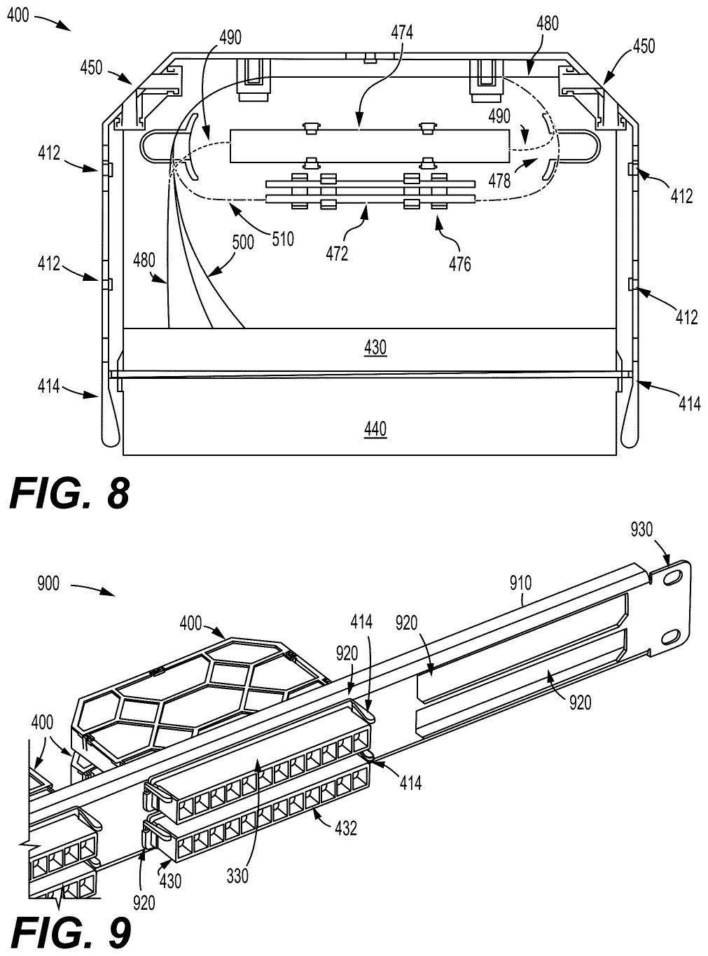

In operation, as generally shown by the top view of the body portion 410 in FIG. 8, the compact adapter module 400 may provide a diverse array of connectivity in a relatively small physical size. While not limiting, FIG. 8 conveys a number of different connections enabled by the structure and aspects of a compact adapter module 400. Solid line 480 corresponds with a direct patching arrangement where a bulkhead adapter 430/440 is connected to an output cable, such as a 3 mm Miniflex® cable. Such direct patching may simply translate a single fiber optic core from the adapter 430/440 to an output cable or separate multiple fiber optic cores housed in a cable into separate ports of a bulkhead adapter 430/440, as shown by lines 500.

The compact adapter module 400 may further support the splitting of a fiber optic core. As shown by segmented line 490, a fiber optic core originating from a bulkhead adapter 430/440 or output cable may be multiplied by a splitter component 474 and routed to either ports of an adapter 430/440 or an output cable. In some embodiments, two fiber optic cores are spliced together with a sleeve component 472 prior to entering the splitter portion 474, as illustrated by segmented line 510. Regardless of what connection aspects are utilized, the body portion 410 may have any number, type, and size of cable organizational portions 478 that may protrude to provide physical support as well as guides for the assorted fiber optic core routing options.

While a compact adapter module 400 may be utilized in isolation, such as in dome closures, wall boxes, and small site installations, various embodiments employ multiple separate modules 400 to provide relatively dense cable organization in static environments, such as racks, patch panels, and server rooms. FIG. 9 is a perspective view of aspects of a cable management system 900 that employs a number of separate compact adapter modules 400 in accordance with assorted embodiments.

As shown, a retention portion 910, for example a retention plate, patch panel, or the like, may be structurally configured with apertures 920 configured to physically support and retain a compact adapter module 400. Although the retention plate 910 may be structurally configured to support and secure any number, type, and size of compact adapter module 400, various embodiments arrange the retention plate 910, and constituent apertures 920, to surround and retain multiple separate modules 400 with matching configurations. That is, each aperture 920 may have a peripheral shape that has keyed surfaces to allow a compact adapter module 400 to be inserted in a single orientation relative to the retention plate 910.

The retention plate 910 may be constructed with one or more mounting portions 930 that allow for attachment with a fixed structure, such as a rack, wall, or compatible space. As illustrated in FIG. 9, the retention plate 910 may be structurally configured to allow the concurrent support of multiple separate modules 400. In accordance with various embodiments, each respective module 400 has tab engagement portions 414 that allow for manual disengagement of the body portion 410 of a module 400 from the plate 910. As such, a technician may efficiently remove a module 400 by manually articulating the respective engagement portions 414. Similarly, insertion of a module 400 into the retention plate 910 may manually articulate the respective engagement portions 414 to provide a secure physical connection.

The combination of the efficient insertion/removal of the respective modules 400 into the retention plate 410 along with the increased density of cable interconnections provided by the collective retention plate 410 provides heightened connectivity and cable management compared to other interconnects, such as interconnects 320/330 of FIG. 3. The ability to employ different interconnecting features and modules 400 with different cable connection capabilities allows the cable management system 900 to provide customized cable density, organization, and adaptability over time while increasing the efficiency of rework operations by allowing individual modules 400 of the retention plate 410 to be moved and accessed.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber optic adapter module for supporting different sized adapter bulkhead shapes, comprising:
a body portion;
a lid portion configured to be coupled with the body portion;
a tray portion configured to be movingly coupled with the body portion;
wherein the body portion includes a cable access portion that is configured to permit a fiber optic cable to enter an interior of the body portion;
wherein the tray portion is configured to be pivotally coupled with the body portion so as to permit selective rotation of the tray portion relative to the body portion between a stowed position and a raised position;
wherein the body portion includes a base portion having a support portion extending from the base portion and being configured to support the tray portion in the stowed position;
wherein the support portion is configured to space the tray portion from the base portions so as to permit fiber optic components and/or slack cable to be stored between the based portion and the tray portion;
wherein the body portion includes an engagement portion that is configured to couple the body portion with a retention portion;
wherein the engagement portion is configured to flex such that the engagement portion can be coupled with and decoupled from the retention portion so as to provide toolless coupling and decoupling of the body portion relative to the retention portion;
wherein the body portion includes a knockout portion configured to be removed from a remainder of the body portion so as to provide an opening that is configured to receive a fiber optic adapter; and
wherein the knockout portion comprises multiple knockout portions that are structurally configured to be separately removed from the body portion such that the knockout portion permits selective sizing of the opening in the body portion so as to alternatively provide a first opening shaped to receive a first bulkhead adapter portion having a first bulkhead adapter shape and being configured to receive a first fiber connector or a second opening shaped to receive a first bulkhead adapter portion having a second bulkhead adapter shape that is different from the first bulkhead adapter shape, and being configured to receive a second fiber connector that is different from the first fiber connector.

2. The adapter module of claim 1, wherein the second opening is larger than the first opening.

3. The adapter module of claim 2, wherein the first opening is sized to receive a twelve fiber LC bukhead adapter, and the second opening is sized to receive a twelve fiber SC bulkhead adapter.

4. The adapter module of claim 1, wherein the engagement portion includes a retention portion coupling portion structurally configured to be disposed on opposite sides of the retention portion so as to couple the engagement portion with the retention portion.

5. The adapter module of claim 1, wherein the lid portion is configured to be removed from the body portion so as to permit the tray portion to be selectively moved the raised position outside of the interior of the body portion so as to provide enhanced access to the base portion.

6. The adapter module of claim 1, wherein the tray portion comprises a splice portion on a surface portion facing away from the base portion.

7. The adapter module of claim 1, wherein the base portion includes an organization portion structurally configured to receive a splitter and/or splice sleeves.

8. A fiber optic adapter module for supporting different adapter bulkhead shapes, comprising:
a body portion;
a lid portion configured to be coupled with the body portion;
a tray portion configured to be movingly coupled with the body portion;
wherein the body portion includes a cable access portion that is configured to permit a fiber optic cable to enter at least a portion of an interior of the body portion;
wherein the tray portion is structurally configured to be pivotally coupled with the body portion so as to permit selective rotation of the tray portion relative to the body portion between a stowed position and a raised position;
wherein the body portion includes a knockout portion configured to be removed from a remaining portion of the body portion so as to provide an opening portion that is configured to receive a fiber optic adapter; and
wherein the knockout portion comprises multiple knockout portions that are structurally configured to be separately removed from the body portion such that the knockout portion permits selective sizing of the opening in the body portion so as to alternatively provide a first opening shaped to receive a first bulkhead adapter portion having a first bulkhead adapter shape and being configured to receive a first fiber connector or a second opening shaped to receive a first bulkhead adapter portion having a second bulkhead adapter shape that is different from the first bulkhead adapter shape, and being configured to receive a second fiber connector that is different from the first fiber connector.

9. The fiber optic adapter module of claim 8, wherein the body portion includes a base portion having a support portion extending from the base portion and being configured to support the tray portion in the stowed position.

10. The fiber optic adapter module of claim 9, wherein the support portion is structurally configured to space the tray portion from the base portion so as to permit fiber optic components and/or slack cable to be stored between the base portion and the tray portion.

11. The fiber optic adapter module of claim 8, wherein the body portion includes an engagement portion that is structurally configured to couple the body portion with a retention portion.

12. The fiber optic adapter module of claim 11, wherein the engagement portion is structurally configured to flex such that the engagement portion can be coupled with and decoupled from the retention portion so as to provide an enhanced coupling and decoupling of the body portion relative to the retention portion that does not require the use of a tool.

13. A fiber optic adapter module configured to support different adapter bulkhead shapes, comprising:
a body portion;
a tray portion structurally configured to be movingly coupled with the body portion;
wherein the body portion includes a cable access portion that is structurally configured to permit a fiber optic cable to enter at least a portion of an interior of the body portion;
wherein the tray portion is structurally configured to be pivotally coupled with the body portion so as to permit selective rotation of the tray portion relative to the body portion between a stowed position and a raised position;
wherein the body portion includes a knockout portion configured to be removed from a remaining portion of the body portion so as to provide an opening portion that is configured to receive a fiber optic adapter; and
wherein the knockout portion comprises multiple knockout portions that are structurally configured to be separately removed from the body portion such that the knockout portion permits selective sizing of the opening in the body portion so as to alternatively provide a first opening shaped to receive a first bulkhead adapter portion having a first bulkhead adapter shape and being configured to receive a first fiber connector or a second opening shaped to receive a first bulkhead adapter portion having a second bulkhead adapter shape that is different from the first bulkhead adapter shape, and being configured to receive a second fiber connector that is different from the first fiber connector.

14. The adapter module of claim 13, further comprising a lid portion structurally configured to be coupled with the body portion.

15. The adapter module of claim 13, wherein the body portion includes a base portion having a support portion extending from the base portion and being configured to support the tray portion in the stowed position.

16. The adapter module of claim 15, wherein the support portion is structurally configured to space the tray portion from the base portion so as to permit fiber optic components and/or slack cable to be stored between the base portion and the tray portion.

17. The adapter module of claim 13, wherein the body portion includes an engagement portion that is structurally configured to couple the body portion with a retention portion.

18. The adapter module of claim 17, wherein the engagement portion is structurally configured to flex such that the engagement portion can be coupled with and decoupled from the retention portion so as to provide an enhanced coupling and decoupling of the body portion relative to the retention portion that does not require use of a tool.

19. The adapter module of claim 17, wherein the engagement portion is structurally configured to cantilever from a wall mounting portion of the body portion.

20. The adapter module of claim 13, wherein the first size of the first bulkhead adapter is larger than the second size of the second bulkhead adapter.
